(19) United States
(12) Patent Application Publication
(10) Pub. No.: US 2019/0358535 A1
(43) Pub. Date: Nov. 28, 2019

(54) GAME MACHINE AND GEAR SHIFTING DEVICE CAPABLE OF ALTERNATIVELY CHANGING GEAR OPERATION MODES

(71) Applicant: INTERNATIONAL GAMES SYSTEM CO., LTD., New Taipei City (TW)

(72) Inventor: A-Chien CHEN, New Taipei City (TW)

(21) Appl. No.: 16/056,554

(22) Filed: Aug. 7, 2018

(30) Foreign Application Priority Data
May 22, 2018 (CN) 201810494665.0

(51) Int. Cl. A63F 13/245; A63F 13/803

(52) U.S. Cl. CPC A63F 13/245; A63F 13/803

(57) ABSTRACT

A game machine includes a host computer and a gear shifting device capable of alternatively changing gear operation modes. The gear shifting device includes an outer frame, a shifting lever module and a switching module. The shifting lever module is movably connected to the outer frame. The switching module is connected to the shifting lever module and the outer frame for switching the current gear-operation mode of the gear shifting device to a first mode or a second mode. The host computer includes a control unit. The control unit is electrically connected to the switching module, so that the switching module is able to switch the current operation mode to the first mode or the second mode.

### RELATED APPLICATIONS

This application claims priority to China Application Serial Number 201810494665.0, filed May 22, 2018, which is herein incorporated by reference.

### BACKGROUND

### Field of Disclosure

The present disclosure relates to a game machine. More particularly, the present disclosure relates to a game machine having a gear shifting device capable of alternatively changing gear operation modes.

### Description of Related Art

A racing game machine (e.g., car-racing) which is commonly found on a large-scale game machine is equipped with a display, a drive seat, a steering wheel, a gear shifting device (i.e., gearshift lever), a throttle pedal, and a brake pedal etc.

In general, gear-shifting operation modes of the gear shifting device of the racing game machine are currently divided into a sequential gear-shifting mode and an H-pattern gear-shifting mode in which the sequential gear-shifting mode is to push the gearshift lever forward or backward sequentially for upshifting or downshifting, and the H-pattern gear-shifting mode is to push the gearshift lever along an H-shaped route for gear-shifting so as to simulate the feeling for using the traditional manual mechanical shifting gear.

However, at present, the large-scale game machines may not to provide a gear shifting device having the sequential gear-shifting mode and the H-pattern gear-shifting mode on the same machine. Therefore, the related providers may need to purchase two game machines with different gear-shifting operation modes. Thereby, not only the manufacturing cost of the racing game machine is increased, but also the variability of the design architecture is limited.

Therefore, a method to develop a solution to effectively overcome the aforementioned inconveniences and disadvantages is a serious concern for the industry.

### SUMMARY

According to one embodiment, a game machine is provided. The game machine includes a host computer and a gear shifting device capable of alternatively changing gear operation modes. The gear shifting device includes an outer frame, a shifting lever module and a switching module. The shifting lever module is movably connected to the outer frame. The switching module is connected to the shifting lever module and the outer frame for alternatively switching the current gear-operation mode of the gear shifting device to one of a first mode and a second mode. The host computer includes a control unit electrically connected to the switching module for triggering the switching module to switch the current gear-operation mode to either the first mode or the second mode.

According to one or more embodiments of the disclosure, in the game machine, the first mode and the second mode are a sequential gear-shifting mode and an H-pattern gear-shifting mode, respectively.

According to one or more embodiments of the disclosure, in the game machine, the gear shifting device includes a first pivotal portion and a second pivotal portion. The first pivotal portion is provided with a first axial direction, and the second pivotal portion is provided with a second axial direction perpendicular to the first axial direction. The shifting lever module includes a main body, an inner frame and a gear shifting lever, the main body that is pivotally connected to the inner frame through the first pivotal portion, and the inner frame that is pivotally connected to the outer frame through the second pivotal portion, and the gear shifting lever that is fixedly connected to the main body, and extended outwards from the outer frame.

According to one or more embodiments of the disclosure, in the game machine, the switching module includes a movable member and two position-limited members. The position-limited members are fixedly connected to the main body, and are spaced apart from each other. The movable member is movably connected to the inner frame for selectively moving in and away from a position between the position-limited members. When the switching module switches the current gear-operation mode to the second mode, and when one of the position-limited members is moved to the movable member by the gear shifting lever, the position-limited member is fixedly held by the movable member to restrict the gear shifting lever.

According to one or more embodiments of the disclosure, in the game machine, the movable member and each of the position-limited members respectively are a magnetic conductive metal and a magnetic member which are able to be attracted to each other, or two magnetic members which are able to be attracted to each other.

According to one or more embodiments of the disclosure, in the game machine, the switching module further includes a first actuator and a screw-threaded stud. The first actuator is fixedly connected to the inner frame, and connected to the movable member for moving the movable member. The screw-threaded stud is movably connected to one side of the inner frame being opposite to the main body, and the movable member is screwed on the screw-threaded stud, and the first actuator is rotatably connected to the screw-threaded stud. When the first actuator is instructed by the control unit, the first actuator rotates the screw-threaded stud to linearly ascend and descend the movable member.

According to one or more embodiments of the disclosure, in the game machine, the first actuator is a servo motor, an electromagnet, a piezoelectric actuator or a linear actuator.

According to one or more embodiments of the disclosure, in the game machine, the switching module further includes a stopper unit. The stopper unit is movably connected to the outer frame. The inner frame is formed with a positioning hole having a first hole-area and a second hole-area. The first hole-area is greater than the second hole-area, and is in communication with the second hole-area. When the switching module switches the current gear-operation mode to the first mode, the stopper unit is moved into the second hole-area to abut against to the inner frame for stopping the inner frame from rotating in relative to the outer frame.

According to one or more embodiments of the disclosure, in the game machine, the switching module further includes a second actuator. The second actuator is fixedly connected to the outer frame, and connected to the stopper unit for moving the stopper unit. The second actuator is instructed by the control unit to move the stopper unit to the inner frame.

According to one or more embodiments of the disclosure, in the game machine, the switching module further includes a fixing rack, a carrier, a rotary disc and a first spring. The fixing rack is fixedly connected to the outer frame. The carrier is liftably disposed on the fixing rack for carrying the stopper unit. The rotary disc is provided with a pushing rod. The first spring is connected to the fixing rack and the carrier for moving the stopper unit and the carrier back to a previous position. The second actuator is rotatably connected to the rotary disc, and is configured to rotate the rotary disc so that the pushing rod of the rotary disc moves the carrier and the stopper unit thereon.

According to one or more embodiments of the disclosure, in the game machine, the gear shifting device further includes an elastic recovery member. The elastic recovery member is fixedly connected to one end of the second pivotal portion, propped against the second pivotal portion and the outer frame, and configured to return the inner frame back to a previous position. The outer frame is formed with a through hole, and the elastic recovery member is a rubber block shaped in a polygon which is as same as a shape of the through hole, and the rubber block is fit to be tightly received in the through hole, and the second pivotal portion penetrates through the rubber block.

According to one or more embodiments of the disclosure, in the game machine, the shifting lever module further includes a retractable pin and a second spring. The retractable pin is retractably received in one end of the gear shifting lever. The second spring is propped against the retractable pin and the gear shifting lever, respectively, and configured to push the retractable pin back to a previous position. The second pivotal portion is formed with a concaved recess having a curved bottom surface therein. One pin terminal of the retractable pin is slidably contacted with the curved bottom surface. When the pin terminal of the retractable pin is at a lowest point of the curved bottom surface, the second spring is in an uncompressed state.

According to one embodiment, a gear shifting device capable of alternatively changing gear operation modes is provided. The gear shifting device includes an outer frame, a first pivotal portion, a second pivotal portion, a shifting lever module, two position-limited members and a movable member. The first pivotal portion is provided with a first axial direction. The second pivotal portion is provided with a second axial direction perpendicular to the first axial direction. The shifting lever module includes a main body, an inner frame and a gear shifting lever. The main body is pivotally connected to the inner frame through the first pivotal portion, and the inner frame is pivotally connected to the outer frame through the second pivotal portion, and the gear shifting lever is fixedly connected to the main body, and extended outwards from the outer frame. The position-limited members are fixedly connected to the main body, and are spaced apart from each other. The movable member is movably connected to the inner frame for selectively moving in and away from a position between the position-limited members. When one of the position-limited members is moved to the movable member by the gear shifting lever, the one of the position-limited members is fixedly held by the movable member to restrict the gear shifting lever.

According to one or more embodiments of the disclosure, the gear shifting device further includes a first actuator and a screw-threaded stud. The first actuator is fixedly connected to the inner frame and connected to the movable member for moving the movable member. The screw-threaded stud is movably connected to one side of the inner frame being opposite to the main body. The movable member is movably screwed on the screw-threaded stud. The first actuator is rotatably connected to the screw-threaded stud for rotating the screw-threaded stud to linearly ascend and descend the movable member.

According to one or more embodiments of the disclosure, the gear shifting device further includes a stopper unit. The stopper unit is movably connected to the outer frame. The inner frame is formed with a positioning hole having a first hole-area and a second hole-area. The first hole-area is greater than the second hole-area, and is in communication with the second hole-area. The stopper unit is configured to move in the second hole-area to abut against to the inner frame for stopping the inner frame from rotating. When the stopper unit stops the inner frame from rotating, the movable member is moved away from the position between the position-limited members.

According to one or more embodiments of the disclosure, the gear shifting device further includes a second actuator. The second actuator is fixedly connected to the outer frame, and connected to the stopper unit for moving the stopper unit.

According to one or more embodiments of the disclosure, the gear shifting device further includes a fixing rack, a carrier, a rotary disc and a first spring. The fixing rack is fixedly connected to the outer frame. The carrier is liftably disposed on the fixing rack for carrying the stopper unit. The rotary disc is provided with a pushing rod. The first spring is connected to the fixing rack and the carrier for moving the stopper unit and the carrier back to a previous position. The second actuator is rotatably connected to the rotary disc, and is configured to rotate the rotary disc so that the pushing rod of the rotary disc moves the carrier and the stopper unit thereon.

According to one or more embodiments of the disclosure, the gear shifting device further includes an elastic recovery member. The elastic recovery member is fixedly connected to one end of the second pivotal portion, propped against the second pivotal portion and the outer frame, and configured to return the inner frame back to a previous position. The outer frame is formed with a through hole, and the elastic recovery member is a rubber block shaped in a polygon which is as same as a shape of the through hole, and the rubber block is fit to be tightly received in the through hole, and the second pivotal portion penetrates through the rubber block.

According to one or more embodiments of the disclosure, in the gear shifting device, the shifting lever module further includes a retractable pin and a second spring. The retractable pin is retractably received in one end of the gear shifting lever. The second spring is propped against the retractable pin and the gear shifting lever, respectively, and configured to push the retractable pin back to a previous position. The second pivotal portion is formed with a concaved recess having a curved bottom surface therein. One pin terminal of the retractable pin is slidably contacted with the curved bottom surface. When the pin terminal of the retractable pin is at a lowest point of the curved bottom surface, the second spring is in an uncompressed state.

According to one or more embodiments of the disclosure, in the gear shifting device, the movable member and each of the position-limited members respectively are a magnetic conductive metal and a magnetic member which are able to be attracted to each other, or two magnetic members which are able to be attracted to each other.

Thus, through the aforementioned structure of the embodiments above, the game machine is able to provide a gear shifting device having the sequential gear-shifting mode and the H-pattern gear-shifting mode for example on the same machine. Therefore, the related providers may not need to purchase plural game machines with different gear-shifting operation modes. Thereby, not only the manufacturing cost of the racing game machine can be reduced, but also the variability of the design architecture can be improved.

The above description is merely used for illustrating the problems to be resolved, the technical methods for resolving the problems and their efficacies, etc. The specific details of the present disclosure will be explained in the embodiments below and related drawings.

### BRIEF DESCRIPTION OF THE DRAWINGS

The accompanying drawings are included to provide a further understanding of the present disclosure and are incorporated in and constitute a part of this specification. The drawings illustrate embodiments of the present disclosure and, together with the description, serve to explain the principles of the present disclosure. In the drawings,

FIG. 1 is a block diagram of a game machine according to one embodiment of the present disclosure;

FIG. 2 is a schematic view of a game machine according to one embodiment of the present disclosure;

FIG. 3 is a perspective view of a gear shifting device according to one embodiment of the present disclosure;

FIG. 4 is an exploded view of the gear shifting device of FIG. 3;

FIG. 5 is a cross sectional view of FIG. 3 viewed along a line A-A;

FIG. 6 is a cross sectional view of FIG. 3 viewed along a line B-B;

FIG. 7A-FIG. 7C are continued operation diagrams of the gear shifting device of FIG. 3 entered into a first mode; and

FIG. 8A-FIG. 8C are continued operation diagrams of the gear shifting device of FIG. 3 entered into a second mode.

### DESCRIPTION OF THE EMBODIMENTS

Reference will now be made in detail to the present embodiments of the present disclosure, examples of which are illustrated in the accompanying drawings. Wherever possible, the same reference numbers are used in the drawings and the description to refer to the same or like parts. According to the embodiments, it will be apparent to those skilled in the art that various modifications and variations can be made to the structure of the present disclosure without departing from the scope or spirit of the present disclosure.

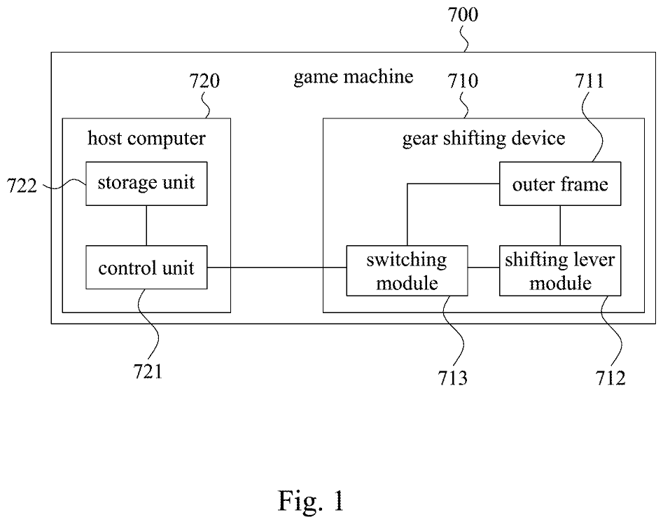

Reference is now made to FIG. 1 in which FIG. 1 is a block diagram of a game machine 700 according to one embodiment of the present disclosure. As shown in FIG. 1, in the embodiment, the game machine 700 includes a gear shifting device 710 and a host computer 720. The gear shifting device 710 includes an outer frame 711, a shifting lever module 712 and a switching module 713. The shifting lever module 712 is movably connected to the outer frame 711. The switching module 713 is connected to the shifting lever module 712 and the outer frame 711 for alternatively switching the current gear-operation mode of the gear shifting device 710 to a first mode or a second mode. The host computer 720 includes a control unit 721. The control unit 721 is electrically connected to the switching module 713 for triggering the switching module 713 to switch the current gear-operation mode to the first mode or the second mode.

For example, the first mode is a sequential gear-shifting mode which is allowed a gear shifting lever 230 of the gear shifting device 710 to repeatedly move within two opposite positions of the gear No. 3 and No. 4 only, and the second mode is an H-pattern gear-shifting mode which is allowed a gear shifting lever 230 of the gear shifting device 710 to move within any position of the gear No. 1-No. 6. However, the disclosure is not limited to those two gear-shifting modes. More specifically, in the embodiment, the host computer 720 can be any generalized computer, and the host computer 720 further includes a storage unit 722. The storage unit 722 is electrically connected to the control unit 721 and built with at least two game software packages therein. When one of the game software packages is executed, the control unit 721 triggers the switching module 713 to switch the current operation mode of the gear shifting device 710 to the sequential schedule mode in response to the game software package; otherwise, when another game software package is executed, the control is performed. The control unit 721 triggers the switching module 713 to switch the current operation mode of the gear shifting device 710 to the H-type shift mode in response to the other game software package.

Therefore, because the gear shifting device 710 capable of alternatively changing gear operation modes can have the sequential gear-shifting mode and the H-pattern gear-shifting mode mentioned above on the same machine, the related providers may not need to purchase plural game machines with different gear-shifting operation modes. Thereby, not only the manufacturing cost of the racing game machine can be reduced, but also the variability of the design architecture can be improved.

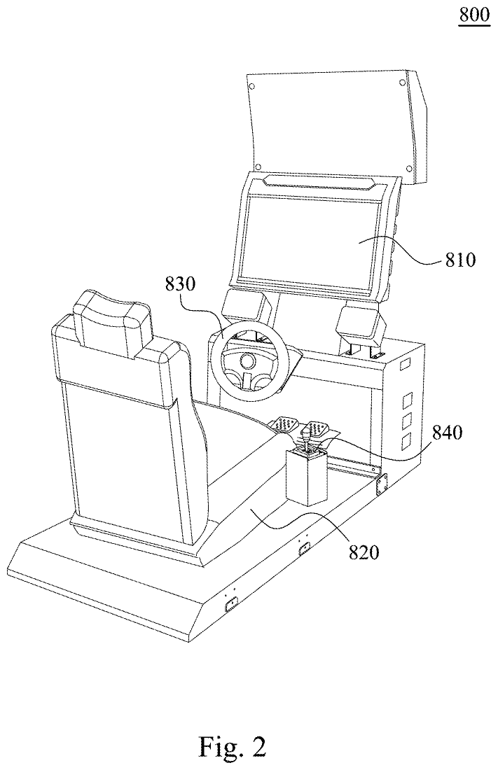

FIG. 2 is a schematic view of a game machine 800 according to one embodiment of the present disclosure. As shown in FIG. 1 and FIG. 2, in one embodiment, a game machine 800 includes a display 810, a drive seat 820, a steering wheel 830 and a gear shifting device 840 capable of alternatively changing gear operation modes. The steering wheel 830 is arranged between the display 810 and the drive seat 820. The gear shifting device 840 is disposed at one side of the drive seat 820 or the steering wheel 830. However, the description above is only one embodiment of the present disclosure. In other embodiments of the gaming machine, the display and the drive seat are not necessary to be equipped in the gaming machine.

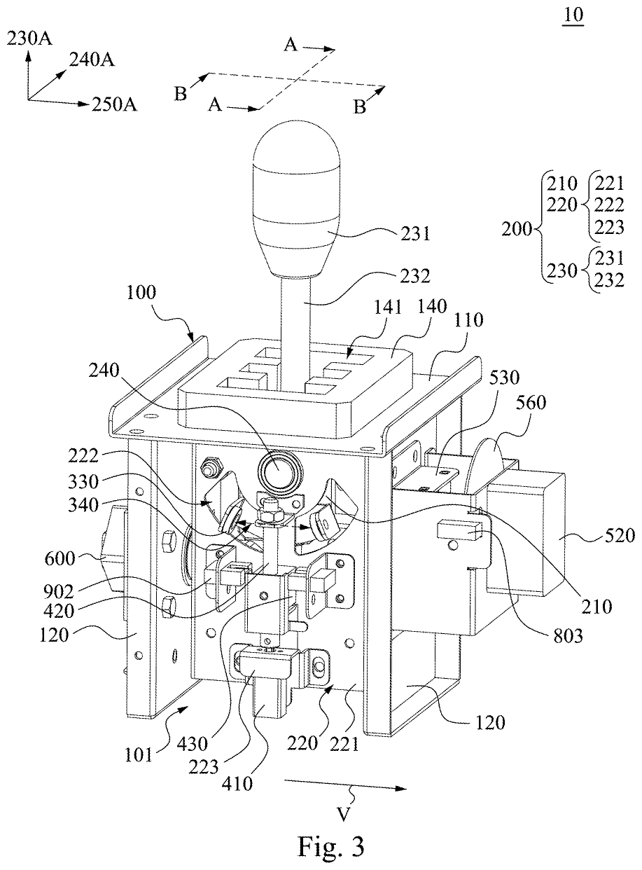

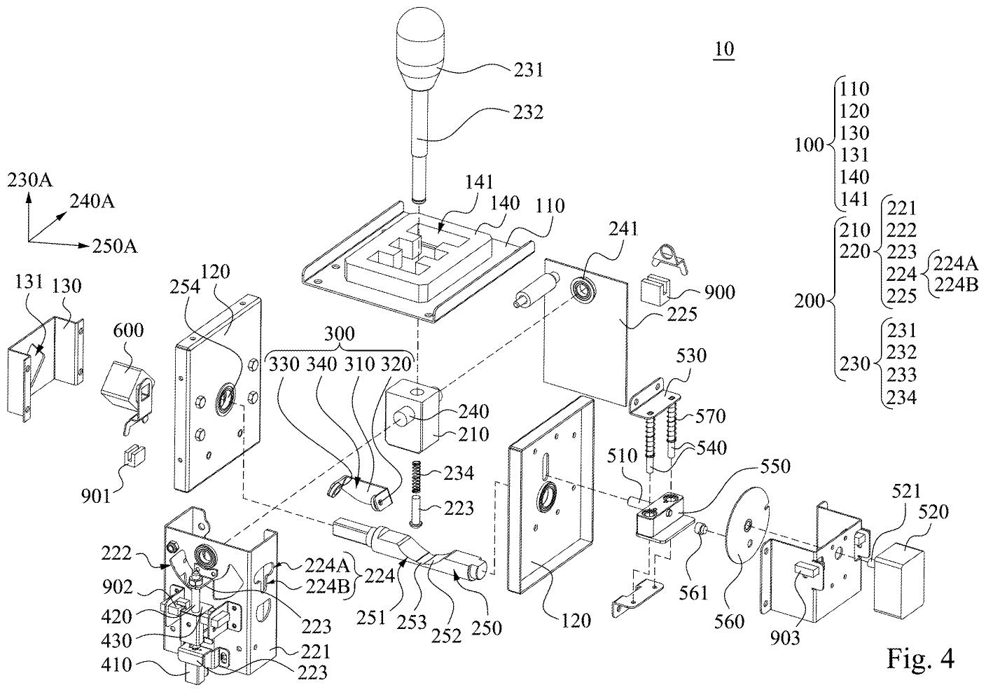

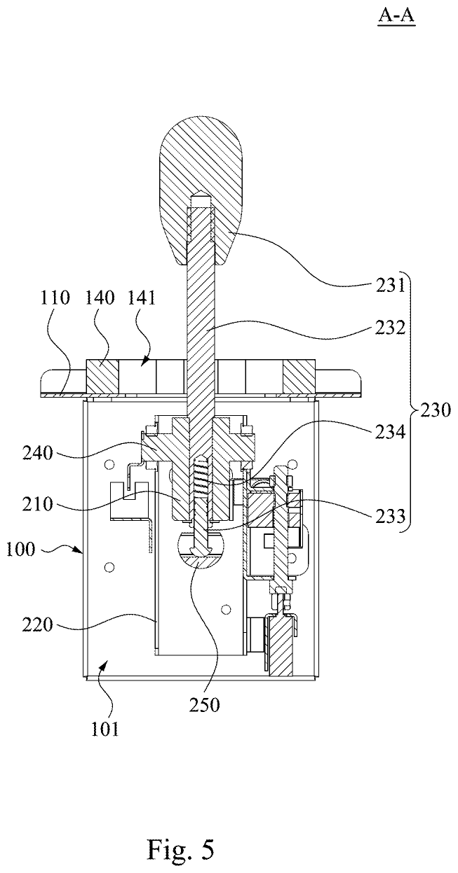

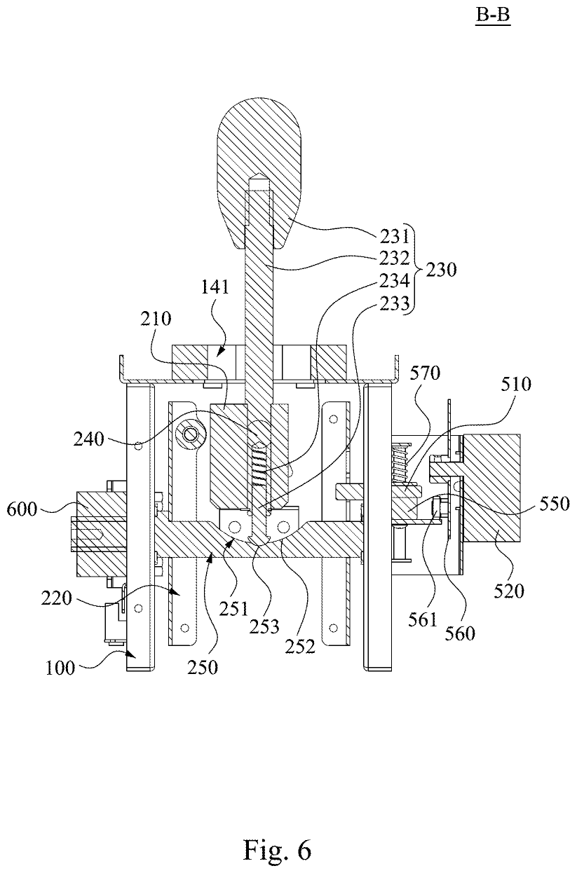

Reference is now made to FIG. 3-FIG. 6 in which FIG. 3 is a perspective view of a gear shifting device 10 according to one embodiment of the present disclosure, FIG. 4 is an exploded view of the gear shifting device 10 of FIG. 3, FIG. 5 is a cross sectional view of FIG. 3 viewed along a line A-A, and FIG. 6 is a cross sectional view of FIG. 3 viewed along a line B-B. As shown in FIG. 3-FIG. 6, in the gear shifting device 10 capable of alternatively changing gear operation modes of the embodiment of the disclosure, the gear shifting device 10 includes an outer frame 100 and a shifting lever module 200. The outer frame 100 is composed of a top plate 110 and at least two shell members 120, and the outer frame 100 is provided with an inner space 101 therein. The shifting lever module 200 is rotatably disposed within the inner space 101. The shifting lever module 200 includes a main body 210, an inner frame 220 and a gear shifting lever 230. The main body 210 is disposed in the inner frame 220, and the main body 210 is pivotally connected to the inner frame 220 through a first pivotal portion 240. In the embodiment, the first pivotal portion 240 is pivotally connected to the inner frame 220 through a first bearing 241. More specifically, the first pivotal portion 240 penetrates through the inner frame 220, and the first pivotal portion 240 is provided with a first axial direction 240A. The inner frame 220 is disposed within the inner space 101 of the outer frame 100, and the inner frame 220 is pivotally connected to the outer frame 100 through a second pivotal portion 250 so that the shifting lever module 200 can be rotatable in relative to the outer frame 100. In the embodiment, the second pivotal portion 250 is pivotally connected to the outer frame 100 through a second bearing 254. More specifically, the inner frame 220 is composed of a frame body 221 and a side plate 225. The second pivotal portion 250 penetrates through the frame body 221 and the outer frame 100. The second pivotal portion 250 is provided with a second axial direction 250A which is perpendicular to the first axial direction 240A.

The gear shifting lever 230 is fixedly connected to the main body 210, and partially extended outwards from the outer frame 100. For example, the gear shifting lever 230 includes a gear shift knob 231 and a shaft stick 232. The shaft stick 232 is disposed in the main body 210. The gear shift knob 231 is installed on one end of the shaft stick 232, and disposed out of the outer frame 100. The shaft stick 232 is provided with a third axial direction 230A which is perpendicular to the first axial direction 240A and the second axial direction 250A. However, the disclosure is not limited that the third axial direction must be perpendicular to the first axial direction and the second axial direction, or the shaft stick 232 is necessarily to have the third axial direction 230A.

Also, the gear shifting device 10 further includes two sensor units 900 and 901. The sensor unit 900 is arranged for sensing the rotation direction of the main body 210 of the shifting lever module 200 as being rotated by the gear shifting lever 230. The sensor unit 901 is arranged for sensing the rotation direction of the shifting lever module 200 as being rotated through the gear shifting lever 230 by a user.

More particularly, the outer frame 100 further includes an external trim panel 140, and the external trim panel 140 is disposed on the top plate 110. The external trim panel 140 is formed with a shifting slot 141, and the shifting slot 141 is in communication with the inner space 101, so that the shaft stick 232 is allowed to be extended outwards from the inner space 101 through the shifting slot 141, and the shaft stick 232 is allowed to be movably received in the shifting slot 141. For example, the shifting slot 141 is formed in a H type or E type pattern, however, the disclosure is not limited thereto, in other embodiment, the shifting slot can be formed in a straight, cross, or other shape; or, the top plate, the external trim panel and the shifting slot are omitted, and a covering member (e.g., leather) is used to cover the top portion of the outer frame such that the gear lever extends outwards through the covering member.

In the embodiment, the shifting lever module 200 further includes a retractable pin 233 and a second spring 234. The retractable pin 233 is disposed on one end of the main body 210 of the shifting lever module 200 opposite to the gear shift knob 231 such that the retractable pin 233 also can be rotated with the main body 210 in relative to the inner frame 220. More particularly, the retractable pin 233 is retractably received in one end of the shaft stick which is opposite to the gear shift knob 231. The second spring 234 is disposed in the shaft stick, and is propped against the retractable pin 233 and the internal of the shaft stick, respectively. Therefore, when the retractable pin 233 compresses the second spring 234, the retractable pin 233 is partially retracted into the shaft stick 232, and the second spring 234 stores a resilient force; when the retractable pin 233 does not compress the second spring 234 anymore, the second spring 234 rebounds to push the retractable pin 233 back to a previous position in the shaft stick 232 using the resilient force.

Furthermore, the second pivot portion 250 is formed with a concaved recess 251 at a long side of the second pivot portion 250, and the major axis direction of the concaved recess 251 is parallel to the second axial direction 250A. The concaved recess 251 is formed with a curved bottom surface 252 therein. A lowest point of the curved bottom surface 252 is in the middle of the concaved recess 251, and the lowest point of the curved bottom surface 252 has a groove 253. The retractable pin 233 extends into the concaved recess 251, and one pin terminal of the retractable pin 233 is slidably contacted with the curved bottom surface 252 in the concaved recess 251. When the main body 210 is rotated, the retractable pin 233 is moved along the curved bottom surface 252 in the second axial direction 250A, so that the curved bottom surface 252 compresses the retractable pin 233 and the second spring, that is, the second spring is in a compressed state; When the retractable pin 233 is moved to the lowest point of the curved bottom surface 252, the curved bottom surface 252 fails to compress the retractable pin 233 and the second spring anymore so that the rebounded second spring is back into an uncompressed state.

In the embodiment, the aforementioned switching module in the gear shifting device 10 further includes a bracket 300 and a movable member 430. The bracket 300 is disposed in the inner frame 220, and is arranged between the inner frame 220 and the main body 210. The bracket 300 includes a frame body 310, two extending arms 320 and two position-limited members 330. The frame body 310 is fixedly connected to the main body 210, and the extending arms 320 are spaced apart from each other, and the extending arms 320 extend outwards from the inner frame 220 through two openings 222, respectively. Each of the position-limited members 330 is fixedly connected to one of the extending arms 320, and the position-limited members 330 are faced to each other, and are spaced apart from each other so that a holding space 340 is formed between the position-limited members 330. However, the disclosure is not limited thereto, the position-limited members 330 may be connected to the inner frame through another style.

In the embodiment, the movable member 430 is movably received in the inner frame 220, and connected to the inner frame 220 for selectively moving in and away from a position (i.e., holding space 340) between the position-limited members 330. Furthermore, in the gear shifting device 10, the switching module further includes a first actuator 410. The first actuator 410 is fixedly connected to the inner frame 220, and is connected with the movable member 430 for altering the location of the movable member 430 so as to move the movable member 430 in or out of the position (i.e., holding space 340) between the position-limited members 330.

More specifically, in the gear shifting device 10, the aforementioned switching module further includes a screw-threaded stud 420. The screw-threaded stud 420 is installed at one side of the inner frame 220 being opposite to the main body 210. More particularly, the screw-threaded stud 420 is installed on two lugs 223 of the inner frame 220, so that a gap is kept between the screw-threaded stud 420 and the inner frame 220. The major axis direction of the screw-threaded stud 420 is perpendicular to the second axial direction 250A. The screw-threaded stud 420 is movably connected to one side of the inner frame 220 being opposite to the main body 210 so that the movable member 430 is rotatably screwed on the screw-threaded stud 420, and the first actuator 410 is rotatably connected to the screw-threaded stud 420. Thus, the first actuator 410 can drive the screw-threaded stud 420 to rotate to linearly and repeatedly ascend or descend the movable member 430 on the screw-threaded stud 420. For example, the first actuator 410 is a linear actuator. The linear actuator is, for example, an electric cylinder, a pneumatic cylinder and the like. However, the present disclosure is not limited thereto, in other embodiments, the first actuator 410 also may be a servo motor, an electromagnet, a piezoelectric actuator or a device using a motor, a linking rod and alike to transfer a rotational motion to a linear motion.

Also, for example, the position-limited members 330 respectively are magnetic members. The movable member 430 is a magnetic conductive metal. The magnetic members (e.g., permanent magnets or electromagnets) and the magnetic conductive metal can be attracted to each other. However, the disclosure is not limited thereto, in other embodiments, the movable member and each of the position-limited members 330 also can be two magnetic members (e.g., permanent magnets or electromagnets) which are able to be attracted to each other. In other embodiments, the movable member and each of the position-limited members 330 also can be vacuum suction discs, double copper-beads door blocks, and the like, which can secure to each other, respectively.

In addition, the gear shifting device 10 further includes two sensor units 902. The sensor units 902 are arranged for sensing whether the movable member 430 is moved in or away from the holding space 340 between the position-limited members 330.

As shown in FIG. 1 and FIG. 4, in the embodiment of the gear shifting device 10, the aforementioned switching module further includes a stopper unit 510. The stopper unit 510 is movably connected to the outer frame 100 for removably moving into the inner frame 220 so as to stop the inner frame 220 from rotating in relative to the outer frame 100. The stopper unit 510 and the movable member 430 are respectively disposed on two adjacent sides of the inner frame 220, and the major axis direction of the stopper unit 510 is parallel to the second axial direction 250A, however, the disclosure is not limited to the type of the stopper unit 510.

In addition, in the gear shifting device 10, the aforementioned switching module further includes a second actuator 520. The second actuator 520 is fixedly connected to the outer frame 100, and connected to the stopper unit 510 for moving the stopper unit 510; or changing the displacement of the stopper unit 510. For example, the second actuator 520 is a rotary motor machine, however, the disclosure is not limited to types of the second actuator.

More specifically, in the gear shifting device 10, the aforementioned switching module further includes a fixing rack 530, a carrier 550, a rotary disc 560 and a first spring 570. The fixing rack 530 is fixedly connected to one of the shell members 120 of the outer frame 100. The carrier 550 is liftably disposed on the fixing rack 530 for carrying the stopper unit 510. The rotary disc 560 is provided with a pushing rod 561. The first spring 570 is connected to the fixing rack 530 and the carrier 550 for moving the stopper unit 510 and the carrier 550 back to a previous position. Furthermore, the fixing rack 530 includes two guide posts 540, and a major axis direction of each of the guide posts 540 is parallel to the third axial direction 230A. A shaft 521 of the second actuator 520 (e.g., rotary motor machine) is pivotally connected to the rotary disc 560 to rotate the rotary disc 560 and the pushing rod 561 so that the pushing rod 561 of the rotary disc 560 downwardly presses the carrier 550 and the stopper unit 510. The carrier 550 is slidably disposed on the guide posts 540. The stopper unit 510 is fixedly connected to the carrier 550.

In the embodiment, the inner frame 220 is formed with a positioning hole 224 having a first hole-area 224A and a second hole-area 224B. The first hole-area 224A is greater than the second hole-area 224B, and is in communication with the second hole-area 224B. The positioning hole 224 is, for example, a gourd-shaped hole, however, the disclosure is not limited to the kind of the positioning hole. Thus, when the stopper unit 510 which have penetrated through the outer frame 100 moves into the second hole-area 224B from the first hole-area 224A of the positioning hole 224, the stopper unit 510 is able to abut against to the inner frame 220 for stopping the inner frame 220 from rotating. On the contrary, when the stopper unit 510 moves into the first hole-area 224A of the positioning hole 224 from the second hole-area 224B, the stopper unit 510 no longer stops the inner frame 220 from rotating.

It is noted, when the stopper unit 510 stops the inner frame 220 from rotating, the movable member 430 is moved away from the position (i.e., holding space 340) between the position-limited members 330.

In addition, the gear shifting device 10 further includes two sensor units 903. The sensor units 903 are arranged for sensing whether the carrier 550 is pressed downwardly by the pushing rod 561.

As shown in FIG.1 and FIG. 2, in the embodiment, the gear shifting device 10 further includes an elastic recovery member 600. The elastic recovery member 600 is fixedly connected to one end of the second pivotal portion 250 opposite to the second actuator 520, and is propped against the second pivotal portion 250 and the outer frame 100. In the embodiment, the outer frame 100 is formed with a through hole 131. For example, the outer frame 100 is provided with an outer attachment rack 130 fastened on one surface of one of the shell members 120 opposite to the second actuator 520. The through hole 131 is formed on the outer attachment rack 130. The second pivotal portion 250 penetrates through the rubber block. The elastic recovery member 600 is a rubber block shaped in a polygon which is as same as a shape of the through hole 131. The rubber block is fit to be tightly received in the through hole 131. In the embodiment, the polygon is a square, however, the disclosure is not limited thereto. However, the disclosure is not limited thereto. In other embodiments, the elastic recovery member may also be a torsion spring.

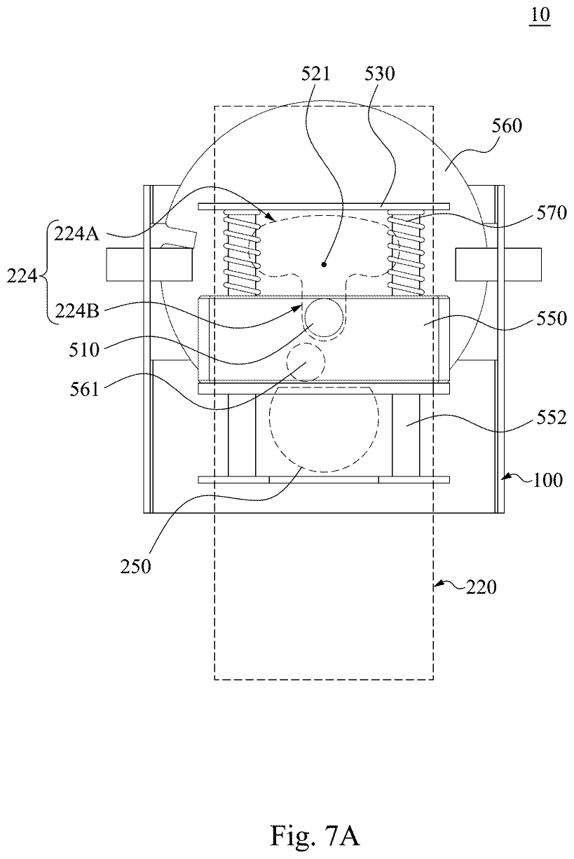

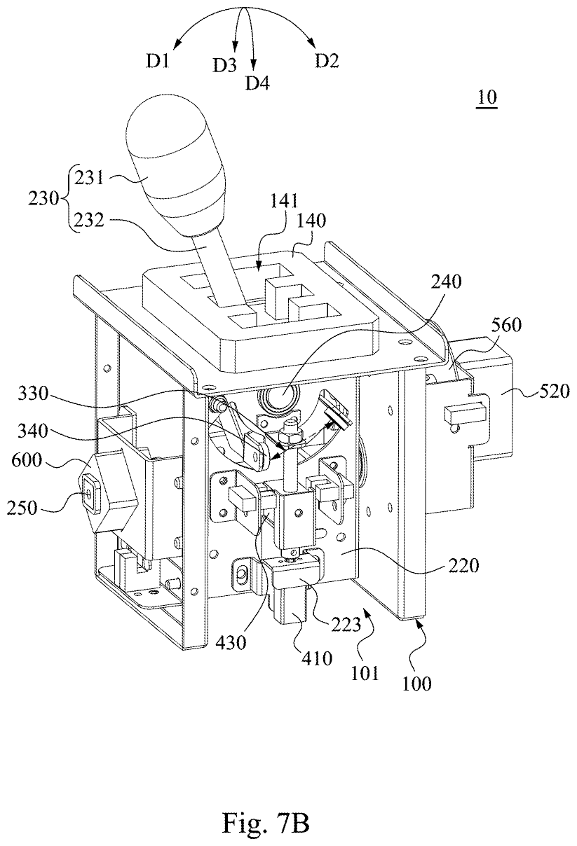

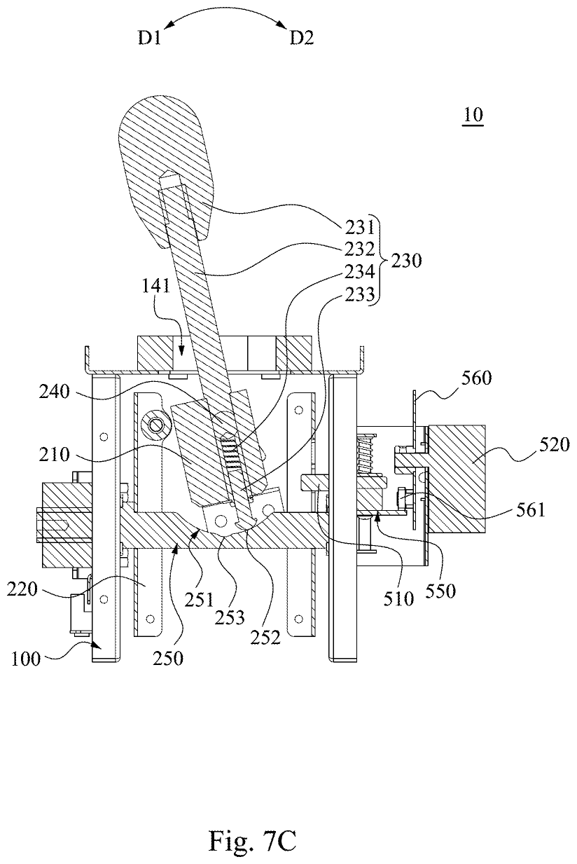

FIG. 7A-FIG. 7C are continued operation diagrams of the gear shifting device 10 of FIG. 3 entered into a first mode. FIG. 7A is to show the current position of the stopper unit 510 viewed in the direction V from the inner frame 220 to the second actuator 520 of FIG. 3. FIG. 7C is a cross-sectional area same as the cross-sectional area of FIG. 6. As shown in FIG. 6 and FIG. 7A, when the current gear-operation mode of the gear shifting device 10 is switched to the first mode, the second actuator 520 starts to rotate the rotary disc 560 to move the pushing rod 561 to press down the carrier 550 so that the stopper unit 510 is dropped into the second hole-area 224B. Thus, the stopper unit 510 stops the inner frame 220 from rotating relative to the outer frame 100. At the moment, as shown in FIG. 7B, the gear shifting lever 230 only can be rotated in the directions D1, D2 rather than the direction D3, D4. Furthermore, the pushing rod 561 at this moment deforms the first spring 570 to store the elastic force.

More specifically, as shown in FIG.7B and FIG. 7C, when a user pushes the gear shifting lever 230 in the direction D1 so as to move the gear shifting lever 230 towards a lateral side of the shifting slot 141 from a middle area of the shifting slot 141, the retractable pin 233 leaves the groove 253 and then moves along the curved bottom surface 252 so that the curved bottom surface 252 compresses the second spring 234 through the retractable pin 233 so as to store a resilient force; on the contrast, when the user does not push the gear shifting lever 230 anymore, since the resilient force of the second spring 234 continues to push the retractable pin 233 back to the previous position until the retractable pin 233 is moved back to the groove 253 (FIG. 6), that is, the second spring cannot push the retractable pin 233 anymore in the uncompressed state. Thus, the resilient force of the second spring 234 moves the gear shifting lever 230 back to the middle area of the shifting slot 141 automatically.

It is noted, when the current gear-operation mode of the gear shifting device 10 is switched to the first mode, the movable member 430 is moved away from the holding space 340, so that the gear shifting lever 230 can be moved to the middle area of the shifting slot 141 automatically rather than fastened by any of the position-limited members 330.

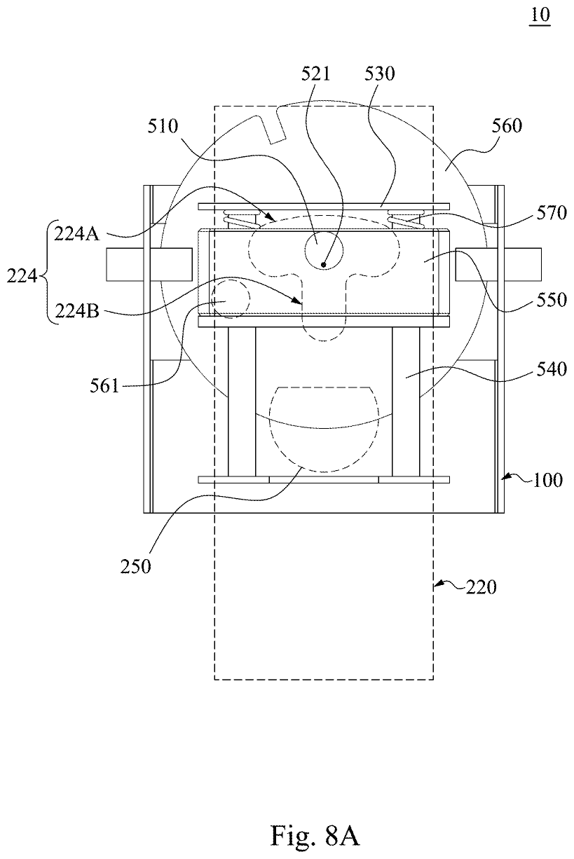

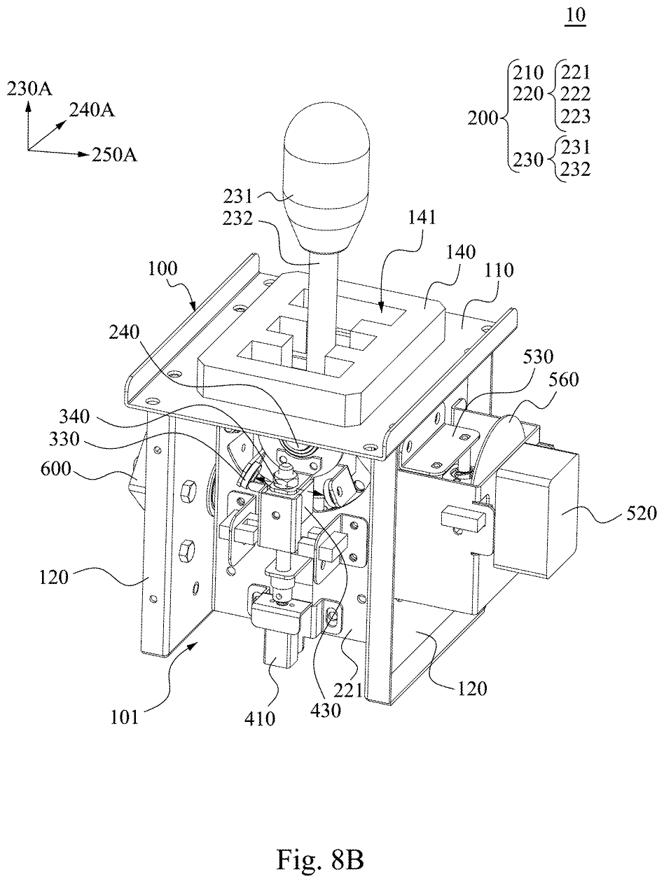

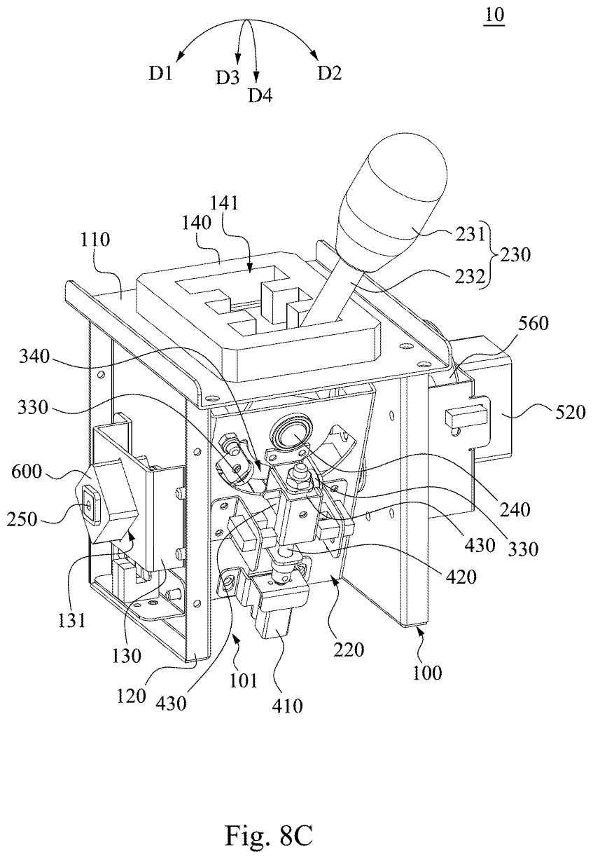

FIG. 8A-FIG. 8C are continued operation diagrams of the gear shifting device of FIG. 3 entered into a second mode. The perspective of FIG. 8A is the same as the perspective of FIG. 7A. As shown in FIGS. 7A and 8A, when the current gear-operation mode of the gear shifting device 10 is switched to the second mode, the second actuator 520 starts to reversely rotate the rotary disc 560 to stop pressing the carrier 550 by the pushing rod 561, so that the resilient force of the first spring 570 pushes the stopper unit 510 back to the first hole-area 224A. Thus, the stopper unit 510 will not stop the inner frame 220 from rotating in relative to the outer frame 100. At this moment, as shown in FIG. 8B, the gear shifting lever 230 not only can rotate in the direction D1, D2, but also can rotate in the direction D3, D4.

As shown in FIG. 1 and FIG. 8B, when the current gear-operation mode of the gear shifting device 10 is switched to the second mode, besides the stopper unit 510 can be lifted back to the first hole-area 224A, the first actuator 410 further rises the movable member 430 to move the movable member 430 into the holding space 340.

Thus, as shown in FIG. 8C, when a user pushes the gear shifting lever 230 in the direction D4 and the direction D2 sequentially so as to move the gear shifting lever 230 towards a corner of the shifting slot 141 from the middle area of the shifting slot 141, one of the position-limited members 330 is moved with the gear shifting lever 230 to physical contact with the movable member 430 which is risen in the holding space 340, and the position-limited member 330 is fixedly secured to the movable member 430. Since the movable member 430 and each of the position-limited members 330 are magnetic conductive metal and magnetic members in the embodiment, each of the position-limited members 330 is able to be attracted by the movable member 430 so as to remain the gear shifting lever 230 at the corner of the shifting slot 141, and not return to the middle area of the shifting slot 141 temporarily. Also, when the gear shifting lever 230 is moved to the corner of the shifting slot 141, the elastic recovery member 600 will be squeezed to store a resilient force by the second pivotal portion 250 which is rotated along with the gear shifting lever 230. On the other hand, after the user exerts force to separate the movable member 430 and the position-limited member 330, the gear shifting lever 230 is moved back to the middle area of the shifting slot 141 automatically through the resilient force of the elastic recovery member 600.

Although the gear shifting device implemented in a game machine is described in the embodiment, however, the disclosure is not limited thereto, the gear shifting device in the disclosure also can be adopted in other industries in other embodiment.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the present disclosure. In view of the foregoing, it is intended that the present disclosure cover modifications and variations of this disclosure provided they fall within the scope of the following claims and their equivalents.

What is claimed is:

1. A game machine, comprising:
a gear shifting device comprising an outer frame, a shifting lever module movably connected to the outer frame, and a switching module connected to the shifting lever module and the outer frame for alternatively switching a current gear-operation mode of the gear shifting device to one of a first mode and a second mode; and
a host computer comprising a control unit electrically connected to the switching module for triggering the switching module to switch the current gear-operation mode to the one of the first mode and the second mode.

2. The game machine of claim 1, wherein the first mode and the second mode are a sequential gear-shifting mode and an H-pattern gear-shifting mode, respectively.

3. The game machine of claim 1, wherein the gear shifting device comprises a first pivotal portion and a second pivotal portion, the first pivotal portion is provided with a first axial direction, and the second pivotal portion is provided with a second axial direction perpendicular to the first axial direction; and
the shifting lever module comprises a main body, an inner frame and a gear shifting lever, the main body that is pivotally connected to the inner frame through the first pivotal portion, and the inner frame that is pivotally connected to the outer frame through the second pivotal portion, and the gear shifting lever that is fixedly connected to the main body, and extended outwards from the outer frame.

4. The game machine of claim 3, wherein the switching module comprises a movable member and two position-limited members, the position-limited members are fixedly connected to the main body, and are spaced apart from each other, the movable member is movably connected to the inner frame for selectively moving in and away from a position between the position-limited members,
wherein, when the switching module switches the current gear-operation mode to the second mode, and when one of the position-limited members is moved to the movable member by the gear shifting lever, the one of the position-limited members is fixedly held by the movable member to restrict the gear shifting lever.

5. The game machine of claim 4, wherein the movable member and each of the position-limited members respectively are a magnetic conductive metal and a magnetic member which are able to be attracted to each other, or two magnetic members which are able to be attracted to each other.

6. The game machine of claim 4, wherein the switching module further comprises:
a first actuator that is fixedly connected to the inner frame, and connected to the movable member for moving the movable member; and
a screw-threaded stud that is movably connected to one side of the inner frame being opposite to the main body, and the movable member is screwed on the screw-threaded stud, and the first actuator is rotatably connected to the screw-threaded stud,
wherein, when the first actuator is instructed by the control unit, the first actuator rotates the screw-threaded stud to linearly ascend and descend the movable member.

7. The game machine of claim 6, wherein the first actuator is a servo motor, an electromagnet, a piezoelectric actuator or a linear actuator.

8. The game machine of claim 3, wherein the switching module further comprises a stopper unit that is movably connected to the outer frame; and
the inner frame is formed with a positioning hole having a first hole-area and a second hole-area, the first hole-area is greater than the second hole-area, and is in communication with the second hole-area,
wherein, when the switching module switches the current gear-operation mode to the first mode, the stopper unit is moved into the second hole-area to abut against to the inner frame for stopping the inner frame from rotating in relative to the outer frame.

9. The game machine of claim 8, wherein the switching module further comprises:
a second actuator that is fixedly connected to the outer frame, and connected to the stopper unit for moving the stopper unit,
wherein, the second actuator is instructed by the control unit to move the stopper unit to the inner frame.

10. The game machine of claim 9, wherein the switching module further comprises:
a fixing rack that is fixedly connected to the outer frame;
a carrier that is liftably disposed on the fixing rack for carrying the stopper unit;
a rotary disc that is provided with a pushing rod; and
a first spring that is connected to the fixing rack and the carrier for moving the stopper unit and the carrier back to a previous position,
wherein the second actuator is rotatably connected to the rotary disc, and is configured to rotate the rotary disc so that the pushing rod of the rotary disc moves the carrier and the stopper unit thereon.

11. The game machine of claim 3, wherein the gear shifting device further comprises:
an elastic recovery member that is fixedly connected to one end of the second pivotal portion, propped against the second pivotal portion and the outer frame, and configured to return the inner frame back to a previous position,
wherein the outer frame is formed with a through hole, and the elastic recovery member is a rubber block shaped in a polygon which is as same as a shape of the through hole, and the rubber block is fit to be tightly received in the through hole, and the second pivotal portion penetrates through the rubber block.

12. The game machine of claim 3, wherein the shifting lever module further comprises:
a retractable pin that is retractably received in one end of the gear shifting lever; and
a second spring that is propped against the retractable pin and the gear shifting lever, respectively, and configured to push the retractable pin back to a previous position,
the second pivotal portion is formed with a concaved recess having a curved bottom surface therein, and one pin terminal of the retractable pin is slidably contacted with the curved bottom surface,
wherein, when the pin terminal of the retractable pin is at a lowest point of the curved bottom surface, the second spring is in an uncompressed state.

13. A gear shifting device capable of alternatively changing gear operation modes, comprising:
an outer frame;
a first pivotal portion that is provided with a first axial direction;
a second pivotal portion that is provided with a second axial direction perpendicular to the first axial direction;
a shifting lever module comprising a main body, an inner frame and a gear shifting lever, the main body that is pivotally connected to the inner frame through the first pivotal portion, and the inner frame that is pivotally connected to the outer frame through the second pivotal portion, and the gear shifting lever that is fixedly connected to the main body, and extended outwards from the outer frame;
two position-limited members that are fixedly connected to the main body, and are spaced apart from each other; and
a movable member that is movably connected to the inner frame for selectively moving in and away from a position between the position-limited members,
wherein, when one of the position-limited members is moved to the movable member by the gear shifting lever, the one of the position-limited members is fixedly held by the movable member to restrict the gear shifting lever.

14. The gear shifting device capable of alternatively changing gear operation modes of claim 13, further comprising:
a first actuator that is fixedly connected to the inner frame, and connected to the movable member for moving the movable member; and
a screw-threaded stud that is movably connected to one side of the inner frame being opposite to the main body, and the movable member is movably screwed on the screw-threaded stud,
wherein the first actuator is rotatably connected to the screw-threaded stud for rotating the screw-threaded stud to linearly ascend and descend the movable member.

15. The gear shifting device capable of alternatively changing gear operation modes of claim 13, further comprising a stopper unit that is movably connected to the outer frame,
the inner frame is formed with a positioning hole having a first hole-area and a second hole-area, the first hole-area is greater than the second hole-area, and is in communication with the second hole-area, the stopper unit that is configured to move in the second hole-area to abut against to the inner frame for stopping the inner frame from rotating,
wherein, when the stopper unit stops the inner frame from rotating, the movable member is moved away from the position between the position-limited members.

16. The gear shifting device capable of alternatively changing gear operation modes of claim 15, further comprising:
a second actuator that is fixedly connected to the outer frame, and connected to the stopper unit for moving the stopper unit.

17. The gear shifting device capable of alternatively changing gear operation modes of claim 16, further comprising:
a fixing rack that is fixedly connected to the outer frame;
a carrier that is liftably disposed on the fixing rack for carrying the stopper unit;
a rotary disc that is provided with a pushing rod; and
a first spring that is connected to the fixing rack and the carrier for moving the stopper unit and the carrier back to a previous position,
wherein the second actuator is rotatably connected to the rotary disc, and is configured to rotate the rotary disc so that the pushing rod of the rotary disc moves the carrier and the stopper unit thereon.

18. The gear shifting device capable of alternatively changing gear operation modes of claim 13, further comprising:
an elastic recovery member that is fixedly connected to one end of the second pivotal portion, propped against the second pivotal portion and the outer frame, and configured to return the inner frame back to a previous position,
wherein the outer frame is formed with a through hole, and the elastic recovery member is a rubber block shaped in a polygon which is as same as a shape of the through hole, and the rubber block is fit to be tightly received in the through hole, and the second pivotal portion penetrates through the rubber block.

19. The gear shifting device capable of alternatively changing gear operation modes of claim 13, wherein the shifting lever module further comprising:
a retractable pin that is retractably received in one end of the gear shifting lever; and
a second spring that is propped against the retractable pin and the gear shifting lever, respectively, and configured to push the retractable pin back to a previous position,
the second pivotal portion is formed with a concaved recess having a curved bottom surface therein, and one pin terminal of the retractable pin is slidably contacted with the curved bottom surface,
wherein, when the pin terminal of the retractable pin is at a lowest point of the curved bottom surface, the second spring is in an uncompressed state.

20. The gear shifting device capable of alternatively changing gear operation modes of claim 13, wherein the movable member and each of the position-limited members respectively are a magnetic conductive metal and a magnetic member which are able to be attracted to each other, or two magnetic members which are able to be attracted to each other.
